(19) United States
(12) Patent Application Publication
(10) Pub. No.: US 2013/0140879 A1
(43) Pub. Date: Jun. 6, 2013

(54) METHOD FOR OPERATING A HYDRAULIC BRAKING SYSTEM OF A VEHICLE AND CONTROL UNIT FOR A HYDRAULIC BRAKING SYSTEM OF A VEHICLE

(71) Applicant: Frank Kneip, Bruchmuhlbach-Miesau (DE)

(72) Inventor: Frank Kneip, Bruchmuhlbach-Miesau (DE)

(21) Appl. No.: 13/578,982

(22) PCT Filed: Dec. 15, 2010
(86) PCT No.: PCT/EP2010/069700

§ 371 Date: Feb. 11, 2013

(30) Foreign Application Priority Data
Feb. 15, 2010 (DE) 10 2010 001 943.7

(51) Int. Cl. B60T 8/17; B60T 8/48; B60T 13/74

(52) U.S. Cl. CPC B60T 8/17; B60T 13/745; B60T 8/48
USPC 303/14; 303/20; 701/70

(57) ABSTRACT

A method and control unit for operating a hydraulic braking system of a vehicle, including: receiving an input, provided by an on board control system, with regard to a setpoint pressure change in at least one wheel brake cylinder of the hydraulic braking system which is connected to a brake master cylinder via at least one brake circuit; displacing at least one sealing element into a sealing position with regard to at least one connecting channel of the brake master cylinder to a brake medium reservoir of the hydraulic braking system; establishing a setpoint conveying variable for at least one brake medium conveying element of the hydraulic braking system for conveying a brake medium volume between at least one storage volume of the hydraulic braking system and a storage-external volume of the at least one brake circuit, taking into consideration the received input; and activating the at least one brake medium conveying element according to the established setpoint conveying variable.

### FIELD OF THE INVENTION

The present invention relates to a method for operating a hydraulic braking system of a vehicle. Furthermore, the present invention relates to a control unit for a hydraulic braking system of a vehicle.

### BACKGROUND INFORMATION

German Patent Application No. DE 196 51 153 B4 describes a hydraulic braking system. In the hydraulic braking system, it is possible to decouple the four wheel brake cylinders from the brake master cylinder with the aid of two cut-off valves connected downstream from the brake master cylinder during external power braking. After decoupling the four wheel brake cylinders, a wheel brake pressure should be adjustable for each wheel individually in each of the four wheel brake cylinders with the aid of a brake unit composed of a pump drive motor, at least one hydraulic pump and at least one hydraulic accumulator. Additionally, German Patent Application No. DE 196 51 153 B4 describes a design of a brake master cylinder which is supposed to allow the brake master cylinder to be used as a pedal simulator after the four wheel brake cylinders have been decoupled.

### SUMMARY

The present invention provides a method for operating a hydraulic braking system of a vehicle, and a control unit for a hydraulic braking system of a vehicle.

The example embodiment of the present invention makes it possible to ensure by “decoupling” the brake master cylinder from the brake medium reservoir connected thereto that a negative pressure or an overpressure built up in the at least one wheel brake cylinder is not compensated for by shifting a brake medium out of the brake medium reservoir or into the brake medium reservoir. This provides the possibility of adjusting a desirable pressure for each wheel individually in the particular wheel brake cylinder by operating the at least one brake medium conveying element. In this way, a desirable braking torque may be applied to the at least one wheel of the vehicle, which is assigned to the particular wheel brake cylinder, without the driver applying braking force. The present invention thus makes it possible that a braking torque is applied to the at least one wheel, without the driver having to apply a certain braking force and/or a corresponding braking distance via a brake input element.

At the same time, the pressure change is adjustable in the at least one wheel brake cylinder of the vehicle with the aid of the present invention, as will be described in greater detail based on the following specific embodiments, without the driver feeling a reaction. In particular, an active pressure build-up is implementable in such a way that the driver does not notice a “concomitant pulling” or “pulling in” of the brake input element, e.g., the brake pedal. Additionally, the driver may also actively and directly “brake into” the at least one wheel brake cylinder, while the method according to the present invention is carried out.

The example method described below and the corresponding control unit are usable to carry out different external power braking operations and/or external pressure buildup operations (brake pressure increases). An external power braking is, for example, includes braking at least one wheel of a vehicle, the pressure buildup for this purpose in the associated wheel brake cylinder not exclusively resulting from a driver braking force and/or an assisting force of a brake booster. Examples of this type of external power braking operations or brake pressure increases are automatic emergency brake programs, ACC, brake disk wipers and/or a prefilling of the wheel brake cylinders. Accordingly, the present invention described here may also be used to build up brake pressure (autonomously, automatically).

In one advantageous specific embodiment of the example method, the at least one sealing element is displaced into the sealing position in such a way that the at least one compensating bore of the brake master cylinder is covered. This ensures a reliable decoupling of the brake master cylinder from the brake medium reservoir. Thus, it is ensured that no brake medium shift may take place between the brake master cylinder and the brake medium reservoir via the at least one connecting channel between the brake master cylinder and the brake medium reservoir which ends in the at least one compensating bore. Additionally, sealing elements and motors for appropriately displacing the sealing elements into the sealing position and out of the sealing position are manufacturable cost-effectively.

The at least one sealing element is preferably displaced into the sealing position with the aid of a motor which is coupled to a sealing element. The at least one sealing element is thus displaced independently from the driver's operation.

In one cost-effective specific embodiment, the at least one sealing element is displaced into the sealing position with the aid of a motor, which is coupled to the at least one sealing element of a brake booster of the hydraulic braking system. Due to the multifunctionality of the brake booster, which is cost-effectively implementable, the installation space may additionally be saved for an extra motor, which is thus not needed for displacing the at least one sealing element.

Preferably, at least one plunger is activated, as the at least one brake medium conveying element, in such a way that an actual brake medium volume corresponding to the established setpoint conveying variable is shifted between at least one plunger storage chamber as the at least one storage volume and a storage-external volume of the at least one brake circuit. Using the at least one plunger has improved NVH (noise vibration harshness) values compared to a conveying system based on a feedback pump. In particular, the at least one plunger allows the brake medium volume to be shifted “smoothly” into or out of the at least one storage volume, without the driver hearing or feeling it based on a “vibrating” or “jittering” of the brake input element, e.g., the brake pedal. This “smooth” shifting is, in particular, neither audible nor noticeable to the driver, without the need of closing a cut-off valve, which is needed between the at least one plunger and the brake master cylinder. A cut-off valve of this type may thus be dispensed with.

It is pointed out that the embodiment of the present invention described here is, however, not limited to the use of at least one plunger. Instead of using one plunger, it is also possible to shift the brake medium volume between the at least one storage volume and the storage-external volume of the at least one brake circuit with the aid of a feedback pump, such as those used in an ESP system, or a corresponding pump. For this purpose, it is advantageous to additionally couple the used brake circuit to a brake medium reservoir by bypassing the brake master cylinder, as will be described below in greater detail. Alternatively or additionally, a pressure storage chamber and/or a two-chamber cylinder may be used. In particular, the two-chamber cylinder allows a “smooth,” dampened volume shift so that the driver does not notice a reaction on the brake input element.

In one advantageous refinement, the example method includes the additional steps: ascertaining an additional driver brake input when a brake input element is operated by the driver of the vehicle; establishing a setpoint assisting force variable with regard to an assisting force of the brake booster to be provided, taking into consideration the driver brake input, as well as additionally taking into consideration the input provided by the on board control system and/or the established setpoint conveying variable; and activating the brake booster according to the established setpoint assisting force variable. Taking into consideration the input and/or the setpoint conveying variable is also understood as taking into consideration a variable, or a corresponding signal, derived from the input provided and/or the setpoint conveying variable. It may also be described as an intensification of the driver braking force being adapted by the brake booster during intervention by the driver of the vehicle in the external power braking or the external pressure build up. This ensures that, when operating the brake input element, the driver does not notice/feel any change in the operating mode thereof due to the hydraulic brake pressure previously built up in the wheel brake cylinders via the external power braking. This ensures an improved ride comfort for the driver of the vehicle due to the embodiment of the refinement of the method.

For example, a brake booster control unit may be switched during or after receiving the input and/or establishing the setpoint conveying variable from a first operating mode in which the brake booster control unit establishes the assisting force to be applied by the brake booster according to a first relation, taking into consideration the driver brake input, into a second operating mode in which the assisting force is established according to a second relation, which is not the same as the first relation, taking into consideration the driver brake input. This specific embodiment is easily implementable.

The advantages described above are also ensured in a corresponding control unit for a hydraulic braking system of a vehicle.

Likewise, the above-mentioned advantages are also implementable with the aid of a corresponding hydraulic braking system.

The hydraulic braking system preferably includes at least one plunger as the brake medium conveying element. Thus, the brake pressure buildup for an external power braking and/or a corresponding active function, such as a brake disk wiper and a prefilling of the brake, may be carried out with the aid of the at least one plunger. This is particularly advantageous since filling or extracting a brake medium into or out of the plunger does not result in any noise perceivable by the driver and in no displacement (vibration) of the brake input element noticeable by the driver.

In one advantageous specific embodiment, the at least one plunger includes a self-locking coupling of a wall component of a plunger storage chamber to a plunger motor. In this case, it is ensured that the self-locking coupling prevents the plunger storage chamber from filling, i.e., the coupling of the plunger from sliding back, at least until a comparably high pressure is reached in the adjacent brake circuit.

Alternatively, the hydraulic braking system may include at least one valve unit which is situated on the input side at the at least one associated plunger. A valve unit of this type ensures in a simple manner that an undesirable inflow of the brake medium into the storage chamber of the plunger and a disadvantageous outflow of the brake medium out of the storage chamber of the plunger are prevented.

The hydraulic braking system preferably includes a brake booster. In this case, the hydraulic braking system may additionally include a brake booster control unit which is designed to establish a setpoint assisting force variable with regard to an assisting force of the brake booster to be provided, taking into consideration a driver brake input provided by a brake input element sensor, as well as additionally taking into consideration the input provided by the on board control system and/or the setpoint conveying variable, and to output a third control signal corresponding to a setpoint assisting force variable to a motor of the brake booster. Thus, it is also ensured in the hydraulic braking system described here that the operating mode of the brake booster is adaptable to the hydraulic pressure, which is built up in the at least one wheel brake cylinder with the aid of the external power braking.

Furthermore, the described advantages are also ensured in a vehicle of this type having the control unit and/or the hydraulic braking system.

### BRIEF DESCRIPTION OF THE DRAWINGS

Additional features and advantages of the present invention are explained below.

FIG. 1 shows a flow chart to illustrate a specific embodiment of the method.

FIG. 2 shows a schematic illustration of a specific embodiment of the control unit.

FIG. 3 shows a schematic illustration of a first specific embodiment of the hydraulic braking system.

FIG. 4 shows a schematic illustration of a first exemplary embodiment for a plunger of the hydraulic braking system.

FIG. 5 shows a schematic illustration of a second exemplary embodiment for a plunger of the hydraulic braking system.

FIG. 6 shows a schematic illustration of a second specific embodiment of the hydraulic braking system.

FIG. 7 shows a schematic illustration of a third specific embodiment of the hydraulic braking system.

### DETAILED DESCRIPTION OF EXAMPLE EMBODIMENTS

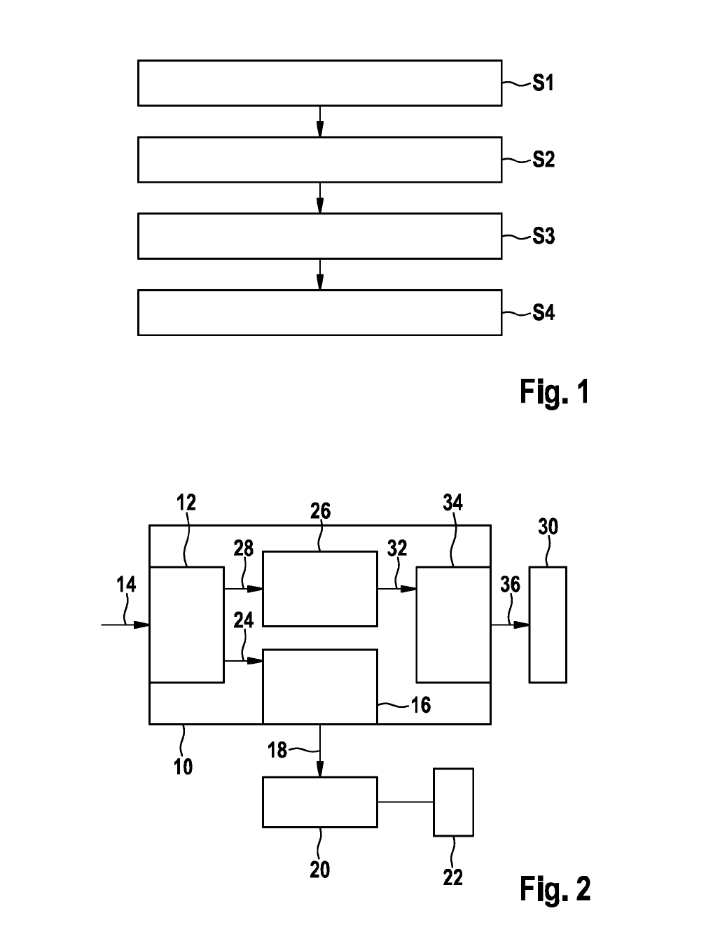

FIG. 1 shows a flow chart to illustrate a specific embodiment of the example method.

In a method step S1, a provided input with regard to a setpoint pressure change in at least one wheel brake cylinder of a hydraulic braking system of a vehicle is received. The at least one wheel brake cylinder is connected to a brake master cylinder of the hydraulic braking system via at least one brake circuit. A connection/coupling of the at least one wheel brake cylinder to the brake master cylinder via at least one brake circuit may be understood to mean that a brake medium, e.g., a brake fluid or a braking gas, is shiftable between the brake master cylinder and the at least one wheel brake cylinder. The brake master cylinder usually has at least one connecting channel to a brake medium reservoir of the hydraulic braking system via which the brake medium is also shiftable.

The received input is provided by an on board control system. The control system may, for example, be an automatic cruise control system, in particular an ACC system (active/adaptive cruise control). Likewise, the control system may be an automatic safety system which is designed to automatically brake the associated vehicle upon recognition of a possible accident situation. Alternatively or additionally, the control system may also be designed to change/adapt a state of at least one component of the hydraulic braking system, such as an internal pressure in a wheel brake cylinder and/or a coating of a brake caliper, according to a surrounding situation and/or a traffic situation. A control system of this type may, for example, also be referred to as a brake disk wiper and/or as a brake prefiller.

Furthermore, the method carried out as a response to the input is thus also referred to as an external power braking and/or as an external pressure buildup. An external power braking of this type and/or a corresponding external pressure buildup may be carried out with the aid of the method described here, without the driver of the vehicle having to apply force to a brake input element. Carrying out this method thus ensures an improved ride comfort for the driver and an improved cooperation of the braking system and the on board control system.

The input may, for example, include a signal and/or a variable with regard to a setpoint pressure change in the at least one wheel brake cylinder, a setpoint pressure in the at least one wheel brake cylinder, a setpoint speed change of the vehicle, a setpoint speed of the vehicle, a setpoint braking torque change of at least one brake caliper of the at least one wheel brake cylinder and/or a hydraulic setpoint braking torque of the at least one brake caliper of the at least one wheel brake cylinder. The input is, however, not limited to the examples listed here.

In a method step S2, at least one sealing element is displaced into a sealing position with regard to the at least one connecting channel. Displacing the at least one sealing element into the sealing position of the at least one connecting channel may be understood to mean that at least one flow-through opening of the at least one connecting channel, through which a brake medium exchange may take place between the brake master cylinder and the brake medium reservoir, is covered by the at least one sealing element in such a way that the brake medium volume which may flow through within a time interval is significantly reduced. In particular, the at least one flow-through opening may be completely covered by the at least one sealing element so that a brake medium volume is reliably prevented from flowing through.

The at least one displaced sealing element is preferably situated in the brake master cylinder. The at least one sealing element may, for example, be displaced into the sealing position in such a way that the at least one compensating bore of the brake master cylinder is covered. Suitable sealing elements for covering the at least one compensating bore of the brake master cylinder are implementable in a simple and cost-effective manner. Additionally, the at least one sealing element may be displaced into the sealing position of the at least one compensating bore using comparably little force. Likewise, the at least one sealing element may be displaced back into a starting position from the sealing position of the at least one compensating bore at a later point in time using relatively little force.

The at least one sealing element is preferably displaced into the sealing position with the aid of a motor which is coupled to the at least one sealing element. Thus, method step S2 may be carried out without the driver of the vehicle having to operate the hydraulic braking system. In particular, the motor of a brake booster of the hydraulic braking system may be used to carry out method step S2. Due to this multifunctionality of the motor of the brake booster, it is not necessary to equip a hydraulic braking system with an additional motor to carry out method step S2.

In another method step S3, a setpoint conveying variable is established for at least one brake medium conveying element of the hydraulic braking system, taking into consideration the received input. The at least one brake medium conveying element, for which the setpoint conveying variable is established, is designed to convey a brake medium volume between the at least one storage volume of the hydraulic braking system and a storage-external volume of the at least one associated brake circuit.

The established setpoint conveying variable may, in particular, be understood as a setpoint function of the at least one brake medium conveying element or a variable describing/establishing the setpoint function. A setpoint conveying variable of this type may, for example, include a setpoint pumping rate of a pump, a setpoint displacement variable of a displaceable component of the at least one storage volume and/or a setpoint brake medium volume to be shifted, or a corresponding variable.

The at least one brake medium conveying element may, for example, include a plunger and/or at least one pump, such as a return pump, in particular. The at least one pump is preferably situated in the hydraulic braking system in such a way that a brake medium volume may be pumped into the at least one storage volume and/or out of the at least one storage volume. The storage volume may, for example, be a pressure storage and/or a chamber of a two-chamber cylinder.

Furthermore, the at least one brake medium conveying element is activated according to the established setpoint conveying variable in a method step S4. The activation preferably takes place in such a way that an actual brake medium volume corresponding to the established setpoint conveying variable is shifted between the at least one storage volume and a storage-external volume of the at least one brake circuit. The storage-external volume may, in particular, be understood as a residual volume of the at least one brake circuit which lies outside the at least one brake circuit.

In one advantageous specific embodiment of the method, the at least one plunger may, for example, be activated as the at least one brake medium conveying element in such a way that an actual brake medium volume corresponding to the established setpoint conveying variable is shifted between at least one plunger storage chamber as the at least one storage volume and the storage-external volume of the at least one brake circuit.

The numbering of above-described method steps S1 through S4 does not determine a chronological sequence of method steps S1 through S4 to be observed for carrying out the method. In particular, method step S2 may be carried out before or after method step S4.

The example method described above may be refined in such a way that an operation of a brake input element by the driver of the vehicle may be responded to when the method is carried out. In particular, it is possible in this case to establish a setpoint assisting force variable with regard to an assisting force of the brake booster to be provided, additionally taking into consideration the received input and/or the setpoint conveying variable, after ascertaining the additional driver brake input, predefined by an operation of the brake input element by the driver. Taking into consideration the received input and/or the setpoint conveying variable may also be understood to mean taking into consideration a variable derived from the received input and/or the setpoint conveying variable and/or a signal provided taking into consideration the received input and/or the setpoint conveying variable.

The established setpoint assisting force variable may be understood as a variable which describes the established setpoint function of the brake booster. For example, the setpoint assisting force variable may include a setpoint assisting force, a change in the setpoint assisting force, and/or a setpoint rotational speed of a brake booster motor.

Subsequently, the brake booster may be activated according to the established setpoint assisting force variable. This adaptation of the operating mode of the brake booster to the external power braking carried out with the aid of method steps S1 through S4, or to the corresponding external pressure buildup, ensures an additional ease of use of the brake input element for the driver, since a response of the brake input element to the operation of the brake input element is not impaired by the external power braking and/or the external pressure buildup in this case.

FIG. 2 shows a schematic illustration of a specific embodiment of the control unit.

It is possible to install control unit 10 for a hydraulic braking system of a vehicle, which is schematically illustrated in FIG. 2, close to the hydraulic braking system. Alternatively, control unit 10 may carry out the following function even if spaced apart from the hydraulic braking system. For example, control unit 10 may also be a subunit of a central vehicle control unit.

As an alternative to control unit 10 which is illustrated in FIG. 2 in a compact manner, a spatially separated implementation of the situatable subunits is also possible. In this case, control unit 10 is understood as an electronics system of the hydraulic braking system composed of multiple subunits. As a compact or individual electronics system of the hydraulic braking system, control unit 10 may likewise carry out yet other functions of a conventional braking electronics system.

Control unit 10 includes an input device 12 which is designed to receive an input signal 14 having a provided input with regard to a setpoint pressure change in at least one wheel brake cylinder (not illustrated) of the hydraulic braking system. Input signal 14 having the input may be provided by an on board control system for which examples have already been described above. Reference is made to the subsequent figure with regard to an illustration of the at least one brake circuit, via which the at least one wheel brake cylinder is connected to a brake master cylinder.

Control unit 10 also includes a first activation device 16 which is activatable with the aid of input device 12 in such a way that first activation device 16 outputs a first control signal 18 to a motor 20 after input device 12 receives input signal 14 having the input. Motor 20 may be mechanically coupled to at least one sealing element 22. The coupling contact between motor 20 and the at least one sealing element 22 may also be designed in such a way that motor 20 is displaceable into a position in which a mechanical contact exists between motor 20 and the at least one sealing element 22. In one preferred embodiment, sealing element 22 is already situated in a starting position adjacent to at least one connecting channel (not illustrated) of the brake master cylinder to a brake medium reservoir of the hydraulic braking system. Motor 20 is activatable with the aid of first control signal 18 in such a way that the at least one sealing element is displaceable into a sealing position with regard to the at least one connecting channel. Reference is made to the previous embodiments with regard to a description of a suitable sealing position of the at least one sealing element 22 which may result in covering at least one compensating bore, for example.

Controlling first activation device 16 by input device 12 may, for example, be understood to mean that input device 12 outputs an activating signal 24 to first activation device 16 after receiving input signal 14. With the aid of an activating signal 24 output in this way, first activation device 16 may be activated to output first control signal 18. Alternatively, input device 12 may also output a signal (not illustrated) to another component of control unit 10, e.g., to subsequently described evaluation device 26, after receiving input signal 14. In this case, the other component is activatable by the signal in such a way that activating signal 24 is output by the other component to first activation device 16.

Additionally, input device 12 is designed to output a reception signal 28, having or according to the received input, to evaluation device 26. Reception signal 28 may, for example, be identical to input signal 14. Evaluation device 26 is designed to establish a setpoint conveying variable for at least one brake medium conveying element 30 of the hydraulic braking system, taking into consideration the input received via reception signal 28. The at least one brake medium conveying element 30, for which the setpoint conveying variable is establishable, is designed to convey a brake medium volume between the at least one storage volume (not illustrated) and a storage-external volume of the at least one brake circuit. Preferred specific embodiments of brake medium conveying element 30 are explained in more detail with reference to the subsequent figure.

After establishing the setpoint conveying variable, evaluation device 26 outputs a corresponding evaluating signal 32 to a second activation device 34. The second activation device is designed to output a second control signal 36 to the at least one brake medium conveying element 30 according to the established setpoint conveying variable. The advantages of this type of activation of the at least one brake medium conveying element 30 with the aid of control unit 10 will be explained below in more detail; motor 20, which is also activated, simultaneously carries out the described displacement movement of the at least one sealing element 22.

Control unit 10 described in the previous paragraphs is implementable as an individual component or as a compact or a multi-piece subunit of braking system control electronics cost-effectively and with little manufacturing effort. In particular control unit 10 does not require, for a reliable operating mode, complex electronic components which are expensive and/or require a lot of installation space.

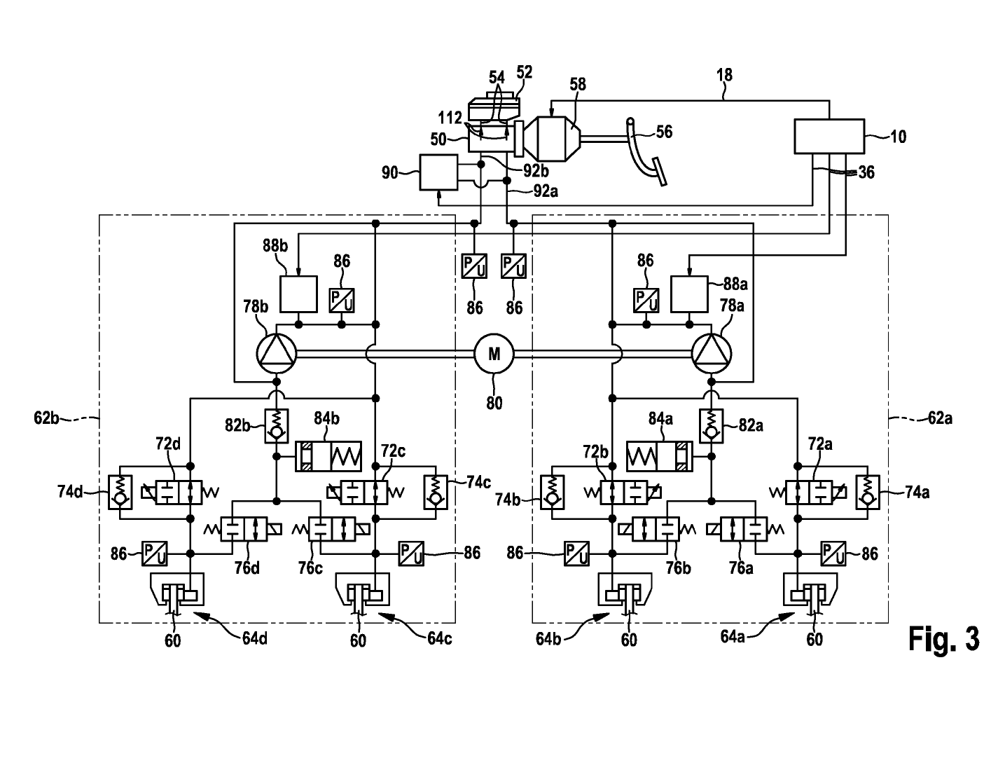

FIG. 3 shows a schematic illustration of a specific embodiment of the hydraulic braking system.

The hydraulic braking system for a vehicle, which is schematically illustrated in FIG. 3, includes a brake master cylinder 50 to which a brake medium reservoir 52 is connected via at least one connecting channel 54. A brake input element 56, which is designed as a brake pedal, for example, is coupled to brake master cylinder 50 in such a way that a driver of the vehicle may cause a pressure change in brake master cylinder 50 with the aid of the hydraulic braking system by operating brake input element 56. To assist the driver, a brake booster 58 is coupled to brake master cylinder 50 in such a way that when brake input element 56 is operated by the driver, a total force of at least the driver braking force applied to brake input element 56 and an assisting force provided by brake booster 58 may result in a pressure change in brake master cylinder 50. This makes it possible to reduce the driver braking force to be applied by the driver for braking at least one wheel 60 of the vehicle.

At least one brake circuit 62a and 62b is connected to brake master cylinder 50 in such a way that a brake medium may flow between brake master cylinder 50 and the at least one brake circuit 62a or 62b. A brake circuit of this type includes at least one wheel brake cylinder 64a through 64d. The illustrated brake circuit has two brake circuits 62a and 62b, each having two wheel brake cylinders 64a through 64d. It is, however, pointed out that the implementability of the hydraulic braking system represented here is not limited to a certain number of brake circuits 62a and 62b having a fixedly predefined number of wheel brake cylinders 64a through 64d. Likewise, the assignment of brake circuits 62a and 62b of the braking system diagonally to the at least four wheels 60 of the vehicle or to their axles or to individual wheels is arbitrary. In another specific embodiment, the hydraulic braking system may also have three brake circuits for an X brake circuit distribution.

In the braking system illustrated in FIG. 3, the two brake circuits 62a and 62b have an identical design. The braking system is, however, not limited to the identical implementation of its brake circuits 62a and 62b. The equipment of each of the illustrated brake circuits 62a and 62b with a wheel inlet valve 72a through 72d, a check valve 74a through 74d situated in parallel thereto, and a wheel outlet valve 76a through 76d per wheel brake cylinder 64a through 64d, as well as a pump 78a or 78b, both pumps 78a and 78b lying on a shared shaft of a motor 80, is illustrated here only as an example. The braking system represented here is not limited to equipping its brake circuits 62a or 62b with components 72a through 78b or to their coupling to one another illustrated here. The equipment of each brake circuit 62a and 62b with an additional check valve 82a or 82b and a storage chamber 84a or 84b, which are situated between the suction side of a pump 78a or 78b, and associated wheel outlet valves 76a through 76d, is also to be interpreted only as optional.

Likewise, illustrated pressure sensors 86 are to be interpreted as optional in their total number per brake circuit 62a or 62b and their placement therein since they do not have to be present.

Each of illustrated brake circuits 62a and 62b has its own plunger 88a or 88b which is situated adjacently to the conveying side of associated pump 78a or 78b. Another plunger 90 has a flow-through opening to each of the two feed lines 92a and 92b, which are coupled to brake master cylinder 50, of the two brake circuits 62a and 62b. Each of plungers 88a, 88b, and 90 may be considered to be a brake medium conveying element having its own installed storage volume of the braking system, with the aid of which a brake medium volume is shiftable between the at least one storage volume of plunger 88a, 88b, and 90 and the storage-external volume of the at least one associated brake circuit 62a and 62b.

It is pointed out that the equipment of the braking system represented here is not limited to a certain number of plungers 88a, 88b, and 90 or their placement on or in the at least one brake circuit 62a or 62b. Furthermore, it is pointed out that alternatively or additionally to equipping the braking system with at least one plunger 88a, 88b, and 90, the function performed there may be carried out partially or entirely with the aid of pumps 78a or 78b and storage chambers 84a and 84b. Optionally, the braking system may also include at least one other brake medium conveying element and/or at least one additional storage volume. For example, an ESP pump and/or a pressure storage and/or a two-chamber cylinder may be used.

Two advantageous exemplary embodiments for plungers 88a, 88b, and 90 are described below.

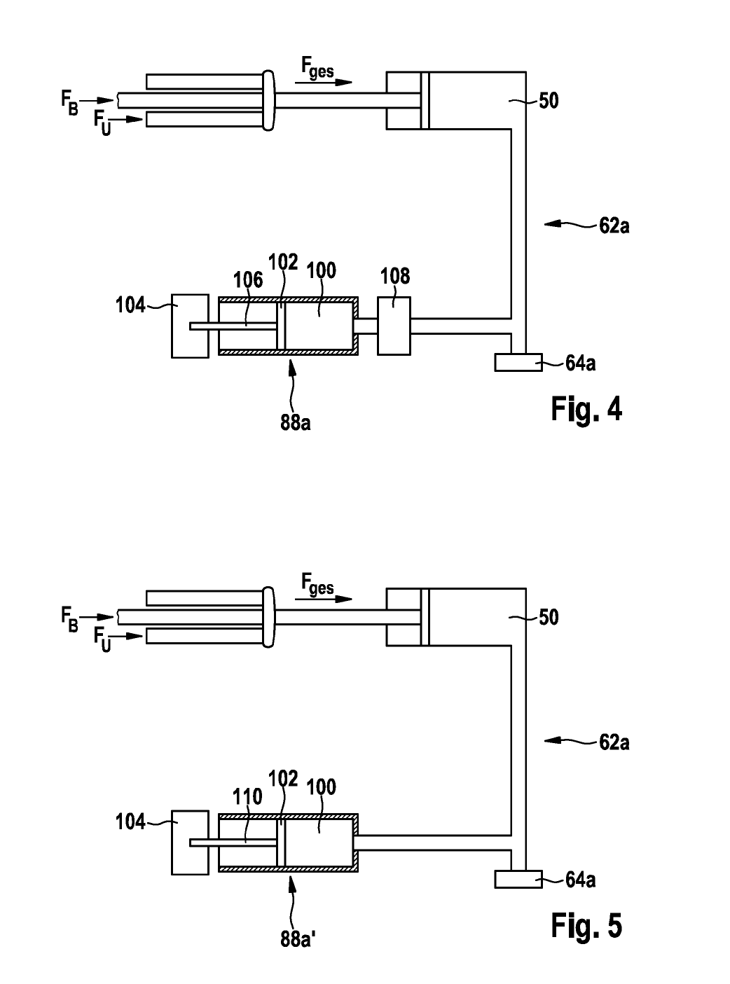

FIG. 4 shows a schematic illustration of a first exemplary embodiment for a plunger of the hydraulic braking system.

Plunger 88a, which is schematically represented in FIG. 4, has a plunger storage chamber 100 and a plunger motor 104 which is connected to a displaceable wall component 102 of plunger storage chamber 100 with the aid of a coupling 106. Due to coupling 106 between plunger motor 104 and displaceable wall component 102, the volume of plunger storage chamber 100, or the brake medium quantity filled into plunger storage chamber 100, is controllable.

To additionally control a brake medium flow between plunger storage chamber 100 and a storage-external volume (schematically illustrated only partially) of brake circuit 62a, a valve unit 108 is situated on the input side of plunger 88a. Valve unit 108 may be designed as a check valve, a switching valve, or a control valve, for example. Plunger 88a and valve unit 108 may also be designed as one piece. The activation of plunger 88a and valve unit 108 is discussed below in greater detail.

A hydraulic pressure in the at least one wheel brake cylinder 64a (the illustration of another wheel brake cylinder was dispensed with), which is assigned to the plunger, is thus not only controllable via a total force F_{ges} which results at least from a driver braking force F_{B} and/or an assisting force F_{U} of the brake booster, but also via an operation of plunger motor 104 and valve unit 108. Thus, there is the possibility of changing the hydraulic pressure in wheel brake cylinder 64a and thus the hydraulic braking torque applied to the associated wheel independently of a driver braking force F_{B} applied by the driver and/or an assisting force F_{U} provided by the brake booster. The resulting advantages are discussed below in greater detail.

FIG. 5 shows a schematic illustration of a second exemplary embodiment for a plunger of the hydraulic braking system.

Due to a self-locking coupling 110 of plunger motor 104 to displaceable wall component 102 of plunger storage chamber 100, plunger 88′a is implemented in such a way that an undesirable filling of plunger storage chamber 100 from the braking system or an inadvertent shifting back of plunger 88′a at least until a relevant pressure is obtained is prevented. One could also say that plunger 88′a is self-locking. Such a plunger 88′a also ensures the advantages listed in the following.

Instead of or additionally to the above-named examples, other exemplary embodiments for a plunger, having an additional gear drive, for example, may also be used.

The hydraulic braking system illustrated in FIG. 3 also has at least one sealing element (not illustrated) which is displaceable with the aid of a motor, to which it may be coupled, into a sealing position with regard to the at least one connecting channel 54. In the illustrated braking system, the motor, with the aid of which the at least one sealing element is displaceable, is a motor of brake booster 58. Brake booster 58 may, for example, be designed as an electromechanical brake booster (i-booster) or as a hydraulic brake booster. The advantageous multifunctionality of brake booster 58, which makes it additionally possible to displace the at least one sealing element with the aid of brake booster 58, is, however, not limited to the types listed here. Brake booster 58 is preferably designed as a controllable/regulatable brake booster, thus allowing for yet other uses of brake booster 58.

The hydraulic braking system also has control unit 10 which is described above. With the aid of first control signal 18, brake booster 58 is, for example, activatable in such a way that the at least one sealing element is displaced in such a way that compensating bores 112 are covered. Plungers 88a, 88b, and 90 are activated via second control signal 36 in such a way that a hydraulic pressure is carried out according to a desired hydraulic braking torque of an external power braking and/or a preferred pressure increase of an external pressure increase in wheel brake cylinders 64a through 64d. Taking into consideration the pressure-volume characteristics curve of the hydraulic pressure, plungers 88a, 88b, and 90 may be activated for each wheel individually in each of wheel brake cylinders 64a through 64g via second control signal 36.

Thus, it is possible in the braking system described here, in the case of an external power braking or an external pressure buildup (active pressure buildup) as is, for example, advantageous for an ACC control, a brake disk wiper and/or a prefilling of the brakes, to dispense with the provision of the force necessary for the external power braking or the external pressure buildup with the aid of a controllable/regulatable brake booster. Control unit 10 having plungers 88a, 88b, and 90 may also be used for an ESP system or an EHB system.

A conventional external power braking or a conventional external brake pressure buildup, which includes the brake booster providing all the force necessary thereto, is associated with the disadvantage that the operating point/working point of the brake booster is changed during the external power braking or external pressure buildup. In this case, the position of brake input element 56 usually also changes, which may, for example, also be referred to as a concomitant pulling of the brake pedal. This is often considered to be irritating when the driver brakes during the external power braking or the external pressure buildup, since the properties of the brake pedal have accordingly changed. In this case, the driver feels an unexpected brake pedal position when he/she touches the brake pedal, for example. If the driver continues to operate the brake pedal, the brake pedal has a completely different feel to it due to the already built up pressure in the system when the driver operates the pedal than when the pedal is operated from a rest/zero position. For example, the starting force, the delay and/or the ratio between a force change and a corresponding path change are changed. Since in the present invention described here, the external power braking or the external pressure buildup may, however, be carried out without the driver noticing a displacement of brake input element 56, this conventional disadvantage is eliminated.

In the braking system illustrated here, a pressure buildup in at least one wheel brake cylinder 64a through 64d may thus be achieved via the at least one plunger 88a, 88b, and 90 with a minimum change of the working point of brake booster 58. For this purpose, brake booster 58 is preferably only activated in such a way that compensating bores 112, i.e., the (hydraulic) connection between brake master cylinder 50 and brake medium reservoir 52, are closed. All it needs to reliably cover the connection between brake master cylinder 50 and brake medium reservoir 52 is a displacement of the at least one sealing element by a comparably small displacement path with the aid of brake booster 58. Subsequently, a constant volume of the brake medium is enclosed in the braking system, i.e., no brake medium exchange takes place between brake master cylinder 50 and brake medium reservoir 52 when compensating bores 112 are covered. Accordingly, a pressure build up is implementable in a simple manner.

If only a certain brake medium volume is conveyed into the braking system by the at least one plunger 88a, 88b, or 90, a pressure buildup results in at least one wheel brake cylinder 64a through 64d. During the pressure buildup, brake booster 58 is controlled/regulated in such a way that compensating bores 112 remain closed. This may take place in a simple manner by position control of brake booster 58. Such a control strategy is particularly advantageous, since usually only minor hardware tolerances are to be observed, i.e., there is one position in which brake booster 58 may be shifted, at which it is ensured that compensating bores 112 are/remain closed and which is not significantly tolerance-prone.

When activating the at least one plunger 88a, 88b, or 90 with the aid of second control signal 36, a pre-pressure, a circuit pressure and/or a wheel pressure provided by at least one pressure sensor 86 may also be taken into consideration by control unit 10. This is advantageous for a high accuracy of an adjusted brake pressure. Alternatively or additionally, a piece of pressure information may also be calculated based on the activating and/or measuring variables of the at least one plunger 88a, 88b, and 90, e.g., an activating current and/or a motor position. In this way, a corresponding, advantageous control of the hydraulic pressure may also be carried out in at least one wheel brake cylinder 64a through 64d.

The at least one plunger 88a, 88b, and 90 may thus also be operated in a position-regulated or position-controlled manner, by evaluating its motor position, for example. This type of a position regulation or position control method is advantageous, since no additional sensors, such as a pressure sensor situated on the plunger, are necessary. This type of position regulation/control preferably takes place by additionally taking into consideration the pressure volume properties of the at least one wheel brake cylinder 64a through 64d. It may be advantageous to store the pressure-volume characteristics curve in an appropriate control unit, e.g., in control unit 10. Since the pressure-volume characteristics curve may have strong oscillations, in particular in the course of its lifetime, it is advantageous to combine the control method with an update of the pressure-volume characteristics curve carried out after a certain time period.

In the braking system described here, the hydraulic pressures in wheel brake cylinders 64a through 64d may also be adjusted for each wheel individually, as is, for example, advantageous in the ESP system. Additionally, the driver may also brake into the braking system during the external pressure buildup or the external power braking. Furthermore, the present invention is associated with the advantage that cut-off valves, such as a switchover valve or a main switching valve, for locking in the pressure in a braking system are no longer needed.

In one refinement, the braking system may also include a brake booster control unit (not illustrated) which is designed to establish a setpoint assisting force variable with regard to an assisting force of brake booster 58 to be provided, taking into consideration a driver brake input provided by a brake input element sensor. The setpoint assisting force variable is preferably established by additionally taking into consideration the input provided by the on board control system and/or the established setpoint conveying variable. Subsequently, a third control signal corresponding to the established setpoint assisting force variable may be output to a motor of brake booster 58 in such a way that the brake booster is activated to provide an assisting force corresponding to the setpoint assisting force variable. This type of implementation of the brake booster control unit is possible in a simple and cost-effective manner.

For example, the control unit and the brake booster control unit may be designed in such a way that the brake booster control unit may be switched with the aid of the control unit, when carrying out external power braking, from a first operating mode in which the assisting force to be applied by the brake booster may be established according to a first relation, taking into consideration the driver brake input, into a second operating mode in which the establishing of the assisting force may be carried out according to a second relation, which is not the same as the first relation, taking into consideration the driver brake input. This specific embodiment is easily implementable.

The brake booster control unit may, in particular, be a subunit of control unit 10. The brake booster control unit may also be designed in one piece with brake booster 58.

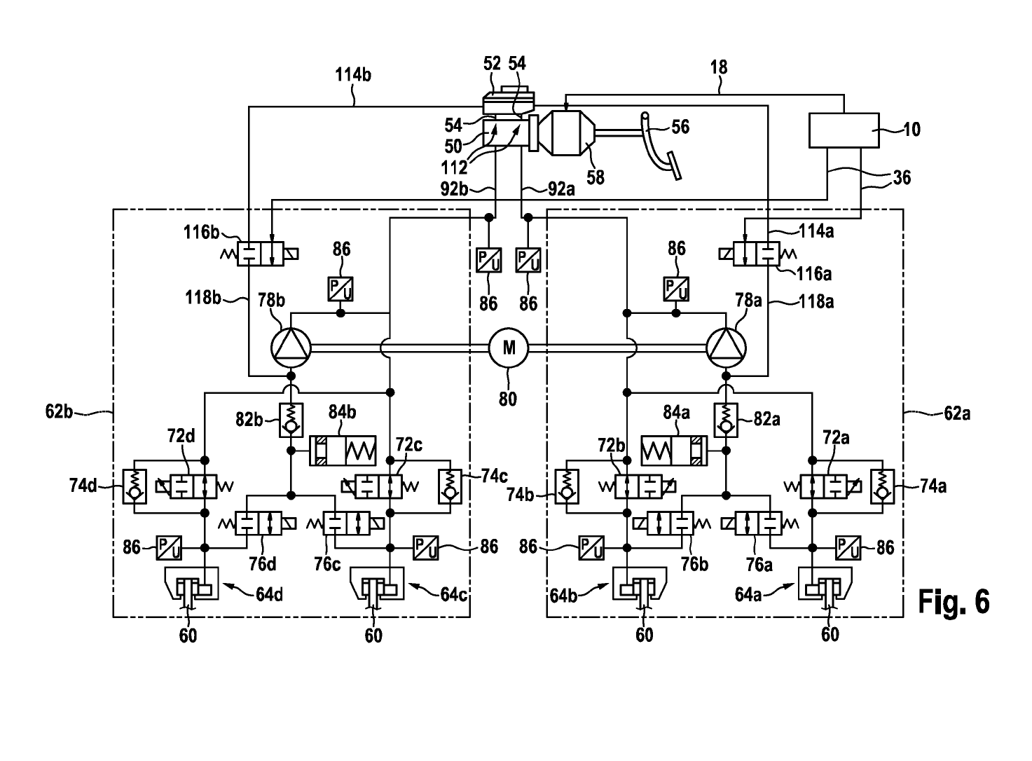

FIG. 6 shows a schematic illustration of a second specific embodiment of the hydraulic braking system.

The braking system illustrated in FIG. 6 has previously described control unit 10 and braking system components 50 through 86. Additionally, the braking system includes for each of brake circuits 62a and 62b cut-off valves 116a and 116b, respectively, which are coupled to brake medium reservoir 52 via a suction line 114a or 114b. Each of cut-off valves 116a and 116b is coupled to the suction side of pump 78a or 78b associated with brake circuit 62a or 62b via its own line 118a or 118b. By activating cut-off valves 116a and 116b with the aid of second control signal 36, the previously mentioned advantages may also be ensured in the braking system of FIG. 6. In particular, in this braking system, a brake medium volume may still be conveyed/shifted between brake medium reservoir 52 and at least one brake circuit 62a and 62b via connecting components 114a, 116a, and 118a, and/or 114b, 116b, and 118b even after covering compensating bores 112.

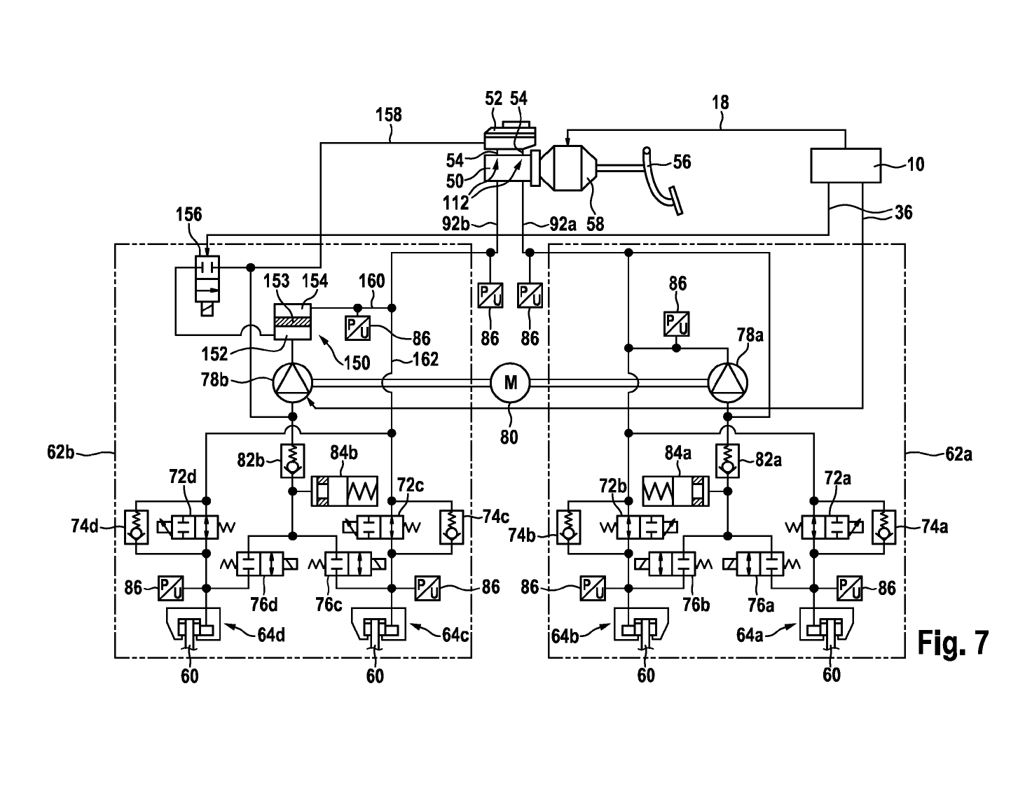

FIG. 7 shows a schematic illustration of a third specific embodiment of the hydraulic braking system.

The braking system illustrated schematically in FIG. 7 has a two-chamber cylinder 150 in second brake circuit 62b instead of a plunger. In one refinement of the illustrated braking system, first brake circuit 62a may also be equipped with a two-chamber cylinder of this type.

Two-chamber cylinder 150 includes a first chamber 152 and a second chamber 154. A separator between the two chambers 152 and 154 includes a shiftable separating element 153, so that a total volume of the two chambers 152 and 154 remains constant when one of the two chambers 152 and 154 becomes bigger/smaller. First chamber 152 is oriented toward a conveying side of pump 78b of second brake circuit 62b. By operating pump 78b, a brake medium volume is thus pumpable into first chamber 152 of two-chamber cylinder 150. Furthermore, an opening of first chamber 152 is connected via a valve 156 to a reservoir line 158, which ends in brake medium reservoir 52. Thus, a brake medium volume may flow from first chamber 152 into storage-external residual volume of second brake circuit 62b when valve 156 is in an open state.

Second chamber 154 of two-chamber cylinder 150 is coupled via an intermediate line 160 to a line 162 which connects wheel inlet valves 72c and 72d to feed line 92b. In this way, a brake medium volume may be shifted between second chamber 154 of two-chamber cylinder 150 and brake master cylinder 50 when switchover valve 68b is open and wheel inlet valves 72c and 72d are closed.

Subsequently, the advantageous cooperation of control unit 10, two-chamber cylinder 150, valve 156, and pump 78b is described. By opening valve 156, a hydraulic connection may be opened between brake medium reservoir 52 and first chamber 152 of two-chamber cylinder 150. Thus, the brake medium may be discharged via the open hydraulic connection from first chamber 152 into brake medium reservoir 52. The resulting pressure reduction in first chamber 152 causes separating element 153 to be shifted between the two chambers 152 and 154. The second chamber thus receives a certain brake medium volume from the storage-external volume of second brake circuit 62b.

By pumping a brake medium volume into first chamber 152, the pressure is accordingly increased therein. The resulting pressure increase causes separating element 153, e.g., a piston, to be shifted between chambers 152 and 154. This results in a pressure build up in second chamber 154 which causes a volume shift from second chamber 154 into the storage-external volume. A significant advantage of the technology according to the present invention described here is that the pulsations of the pump are reduced/minimized by two-chamber cylinder 150 in its function as a damper.

In one preferred embodiment, brake booster 58 is coupled to brake master cylinder 50 in such a way that when brake input element 56 is operated by the driver, a total force of at least the driver braking force applied to brake input element 56 and an assisting force provided by brake booster 58 may result in a pressure change in brake master cylinder 50. Here, coupling is not necessarily understood as a mechanical connection; it may also be understood as the transmission of a force. It is likewise possible that the brake booster may cause a pressure change in brake master cylinder 50 with the aid of an assisting force, without the driver contributing a driver braking force to the total force.

1-12. (canceled)

13. A method for operating a hydraulic braking system of a vehicle, comprising:
receiving an input provided by an on board control system with regard to a setpoint pressure change in at least one wheel brake cylinder of the hydraulic braking system connected to a brake master cylinder via at least one brake circuit;
displacing at least one sealing element into a sealing position with regard to at least one connecting channel of the brake master cylinder to a brake medium reservoir of the hydraulic braking system as a function of the input;
establishing a setpoint conveying variable for at least one brake medium conveying element of the hydraulic braking system for conveying a brake medium volume between at least one storage volume of the hydraulic braking system and a storage-external volume of the at least one brake circuit taking into consideration the received input; and
activating at least one brake medium conveying element according to the established setpoint conveying variable.

14. The method as recited in claim 13, wherein the at least one sealing element is displaced into the sealing position in such a way that the at least one compensating bore of the brake master cylinder is covered.

15. The method as recited in claim 13, wherein the at least one sealing element is displaced into the sealing position with the aid of a motor of a brake booster of the hydraulic braking system, which is coupled to the at least one sealing element.

16. The method as recited in claim 12, wherein at least one plunger is activated as at least one brake medium conveying element in such a way that an actual brake medium volume corresponding to the established setpoint conveying variable is shifted between at least one plunger storage chamber as at least one storage volume and the storage-external volume of the at least one brake circuit.

17. The method as recited in claim 12, further comprising:
ascertaining an additional driver brake input when the driver of the vehicle operates a brake input element;
establishing a setpoint assisting force variable with regard to an assisting force of the brake booster to be provided taking into consideration the driver brake input, and taking into consideration at least one of the input provided by the on board control system, and the established setpoint conveying variable; and
activating the brake booster according to the established setpoint assisting force variable.

18. A control unit for a hydraulic braking system of a vehicle, comprising:
an input device to receive an input provided by an on board control system with regard to a setpoint pressure change in at least one wheel brake cylinder of the hydraulic braking system which is connected to a brake master cylinder via at least one brake circuit;
a first activation device which is activatable with the aid of the input device in such a way that the first activation device outputs, after the input device has received the input, a first control signal to a motor which may be coupled to the at least one sealing element which is situated adjacently to at least one connecting channel of the brake master cylinder to a brake medium reservoir of the hydraulic braking system, the motor being activatable with the aid of the first control signal in such a way that the at least one sealing element is displaceable into a sealing position with regard to the at least one connecting channel;
an evaluation device which establishes a setpoint conveying variable for at least one brake medium conveying element of the hydraulic braking system for conveying a brake medium volume between at least one storage volume of the hydraulic braking system and a storage-external volume of the at least one brake circuit taking into consideration the received input; and
a second activation device which is designed to output a second control signal according to the established setpoint conveying variable to the at least one brake medium conveying element.

19. A hydraulic braking system for a vehicle, comprising:
a brake master cylinder;
at least one wheel brake cylinder connected to a brake master cylinder via at least one brake circuit;
a brake medium reservoir connected to the brake master cylinder via at least one connecting channel;
a motor which may be coupled to at least one sealing element and with the aid of which the at least one sealing element is displaceable into a sealing position with regard to the at least one connecting channel;
at least one storage volume and at least one brake medium conveying element with the aid of which a brake medium volume is shiftable between the at least one storage volume and a storage-external volume of the at least one brake circuit; and
a control unit including an input device to receive an input provided by an on board control system with regard to a setpoint pressure change in the at least one wheel brake cylinder of the hydraulic braking system which is connected to the brake master cylinder via at least one brake circuit, a first activation device which is activatable with the aid of the input device in such a way that the first activation device outputs, after the input device has received the input, a first control signal to the motor which may be coupled to the at least one sealing element which is situated adjacently to the at least one connecting channel of the brake master cylinder to the brake medium reservoir of the hydraulic braking system, the motor being activatable with the aid of the first control signal in such a way that the at least one sealing element is displaceable into a sealing position with regard to the at least one connecting channel, an evaluation device which establishes a setpoint conveying variable for at least one brake medium conveying element of the hydraulic braking system for conveying a brake medium volume between at least one storage volume of the hydraulic braking system and a storage-external volume of the at least one brake circuit taking into consideration the received input, and a second activation device which is designed to output a second control signal according to the established setpoint conveying variable to the at least one brake medium conveying element.

20. The hydraulic braking system as recited in claim 19, wherein the hydraulic braking system includes at least one plunger as the at least one brake medium conveying element.

21. The hydraulic braking system as recited in claim 20, wherein the at least one plunger includes a self-locking coupling of a displaceable wall component of a plunger storage chamber to a plunger motor.

22. The hydraulic braking system as recited in claim 20, wherein the hydraulic braking system includes at least one valve unit which is situated on an input side at the at least one associated plunger.

23. The hydraulic braking system as recited in claim 20, wherein the hydraulic braking system includes a brake booster and a brake booster control unit which establishes a setpoint assisting force variable with regard to an assisting force of the brake booster to be provided, taking into consideration a driver brake input provided by a brake input element sensor, and additionally taking into consideration at least one of the input provided by the on board control system and the setpoint conveying variable, and to output a third control signal corresponding to a setpoint assisting force variable to a motor of the brake booster.

24. A vehicle having a control unit, the control unit including an input device to receive an input provided by an on board control system with regard to a setpoint pressure change in at least one wheel brake cylinder of the hydraulic braking system which is connected to a brake master cylinder via at least one brake circuit, a first activation device which is activatable with the aid of the input device in such a way that the first activation device outputs, after the input device has received the input, a first control signal to a motor which may be coupled to the at least one sealing element which is situated adjacently to at least one connecting channel of the brake master cylinder to a brake medium reservoir of the hydraulic braking system, the motor being activatable with the aid of the first control signal in such a way that the at least one sealing element is displaceable into a sealing position with regard to the at least one connecting channel, an evaluation device which establishes a setpoint conveying variable for at least one brake medium conveying element of the hydraulic braking system for conveying a brake medium volume between at least one storage volume of the hydraulic braking system and a storage-external volume of the at least one brake circuit taking into consideration the received input, and a second activation device which is designed to output a second control signal according to the established setpoint conveying variable to the at least one brake medium conveying element.
